(19) United States
(12) Patent Application Publication
(10) Pub. No.: US 2006/0176176 A1
(43) Pub. Date: Aug. 10, 2006

(54) Apparatus and method for setting route in sensor network

(75) Inventors: Kyung-lim Kang, Suwon-si (KR); Jae-hoon Kim, Seoul (KR); Jung-ho Kim, Suwon-si (KR); Yong-sung Roh, Echeon-si (KR); Jeong-sik In, Seoul (KR); Young-gon Choi, Suwon-si (KR); Singh Shubhranshu, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/334,554

(22) Filed: Jan. 19, 2006

(30) Foreign Application Priority Data
Feb. 4, 2005 (KR) 2005-10761

(51) Int. Cl. G08B 1/08; H04Q 7/00

(52) U.S. Cl. 340/539.26

(57) ABSTRACT

A method of setting a route for effective data transmission in a sensor network including a movable sink node and a plurality of sensor nodes which collect data requested by the movable sink node, the method including: transmitting an agent requesting message from the movable sink node to the sensor nodes; receiving a first agent acceptance message from a first sensor node of the sensor nodes; and selecting, as an agent node, the first sensor node. By using the sensor nodes which are static, the number of data transmission can be saved, thereby reducing power consumption in the respective sensor nodes and also preventing retardation of data transmission.

### CROSS-REFERENCE TO RELATED APPLICATIONS

This application is based upon and claims the benefit of priority under 35 U.S.C. § 119(a) from Korean Patent Application No. 10-2005-0010761, filed Feb. 4, 2005 in the Korean Patent Office, the entire contents of which are incorporated herein by reference.

### BACKGROUND OF THE INVENTION

1. Field Of The Invention

Devices, systems, and methods consistent with the invention relate to a setup of a route among sensor nodes and sink nodes constituting a sensor network, and more particularly, to setting a route for transmitting data collected by the sensor nodes to the sink nodes.

2. Description of the Related Art

In general, mobile communication systems transceive data between a mobile terminal and a base station. In such an arrangement, the mobile terminal and the base station may directly transmit and receive data without any other mobile terminals or nodes therebetween. However, when transmitting the data collected by a sensor node to a sink node, the sensor network may either transmit the data directly to the sink node, or use other sensor nodes. Hereinbelow, nodes constituting such a sensor network, and the function of the nodes, will be described with reference to FIG. 1.

As shown in FIG. 1, the sensor network comprises a sink node and a plurality of sensor nodes (illustrated by the shaded circles in FIG. 1). Although only one sink node is illustrated in FIG. 1, at least two sink nodes may be included in the sensor network as set by a user.

In view of a request by the sink node, the sensor nodes collect data regarding a target set by a user. The target data collected by a first one of the sensor nodes may include information about the ambient temperature or a moving object. The data collected by the first one of the sensor nodes is transmitted to the sink node, which receives data transmitted from all of the sensor nodes constituting the sensor network. Sensor nodes that are located within a predetermined distance from the sink node transmit the data directly to the sink node. However, distant sensor nodes that are located beyond the predetermined distance from the sink node transmit the data to another adjacent sensor node located between itself and the sink node, instead of directly transmitting the data to the sink node.

The distant sensor nodes transmit the data via the adjacent nodes to minimize power consumption for data transmission, since, generally, the power consumed for transmission of data from the sensor node to the sink node is proportional to a distance between the sink node and the sensor node. Hereinbelow, the adjacent node relaying the data from the distant sensor nodes are referred to as ‘relay nodes.’ It is understood that the relay node may transmit data collected by itself to the sink node using other relay nodes, or directly.

As described above, each sensor node collects and transmits the target data to the sink node. However, in general, the sink node is not static but movable.

FIG. 2 shows a process of transmitting target data to a movable sink node. This process may be applied, for example, when transmitting temperature information of a certain region to a moving vehicle. By using this process, the vehicle can receive the temperature information of the certain region.

In this process, the sensor nodes search for a route requiring minimum power at regular time intervals, in order to transmit the collected data to the sink node. Such a route search is performed more frequently when the sink node is movable. However, such a more frequent search causes: (1) increased load in the sensor network, thereby retarding transmission of the collected data; and (2) increased power consumption, as the respective sensor nodes constituting the sensor network have to perform the route search more frequently.

### SUMMARY OF THE INVENTION

An aspect of the present invention is to provide a method for transmitting collected data efficiently from a sensor node to a movable sink node.

Another aspect of the present invention is to provide a method for minimizing power consumption required to set a route for transmitting data collected by a sensor node.

Yet another aspect of the present invention is to provide a method for reducing data transmission delay by reducing the number of searches for a data transmission route.

In one aspect of the invention, there is provided a method for setting a data transmission route in a sensor network comprising a movable sink node and a plurality of sensor nodes which collect data requested by the movable sink node, the method including: transmitting an agent requesting message from the movable sink node to the sensor nodes; receiving a first agent acceptance message from a first sensor node of the sensor nodes; and selecting, as an agent node, the first sensor node.

In another aspect of the invention, there is a data transmission route setting system including: a plurality of sensor nodes which collect data; and a movable sink node which transmits an agent requesting message to the sensor nodes, which receives a first agent acceptance message from a first sensor node of the sensor nodes, and which selects, as an agent node, the first sensor node.

### BRIEF DESCRIPTION OF THE DRAWING FIGURES

The above and/or other aspects of the invention will become more apparent by describing in detail exemplary embodiments thereof with reference to the attached drawings, in which;

FIG. 1 illustrates a general sensor network comprising a sink node and a plurality of sensor nodes;

FIG. 2 illustrates a movable sink node;

FIG. 3 is a flowchart illustrating a process of setting an agent node in the sink node, according to an embodiment of the present invention;

FIG. 4 is a flowchart illustrating a process of requesting collection of data by the sink node;

FIG. 5 illustrates a process of transmitting the data collected by the sensor node, according to an exemplary embodiment of the present invention; and

FIG. 6 illustrates a process of resetting an agent node by the sink node, according to an exemplary embodiment of the present invention.

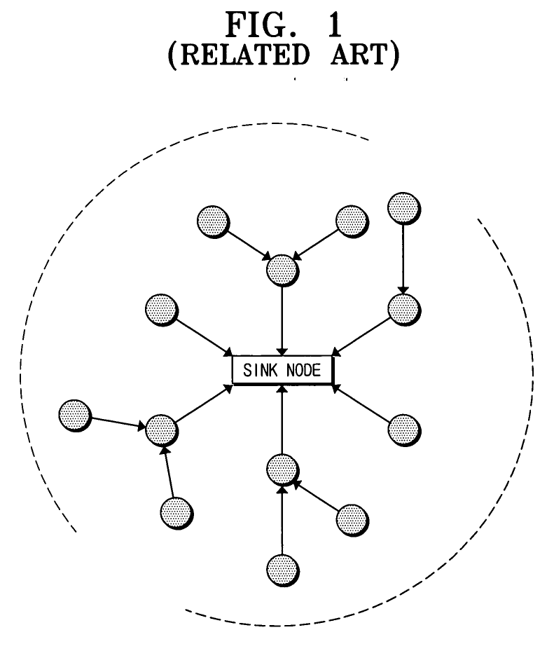

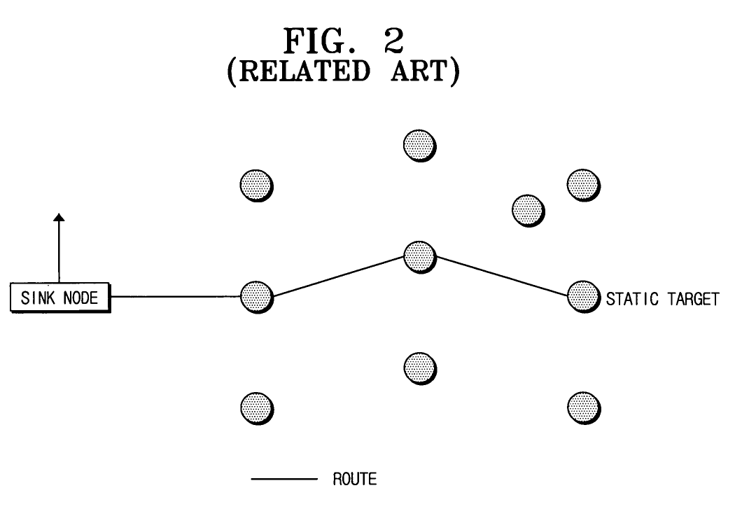

### DETAILED DESCRIPTION OF THE EXEMPLARY EMBODIMENTS

Exemplary embodiments of the invention will now be described below by reference to the attached Figures. The described exemplary embodiments are intended to assist the understanding of the invention, and are not intended to limit the scope of the invention in any way.

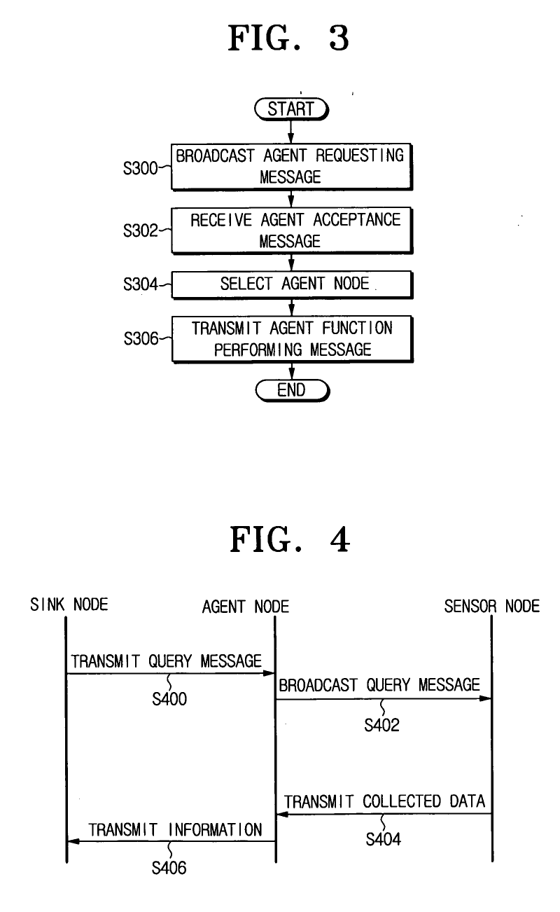

FIG. 3 shows a process of setting an agent node by a sink node according to an exemplary embodiment of the invention. The sink node, which is movable, sets a certain sensor node as an agent node to carry out a function of the sink node. Hereinafter, a process of setting the agent node will be described with regard to FIG. 3.

In operation S300, the sink node broadcasts a message (i.e., an “agent requesting message”) requesting adjacent sensor nodes to function as an agent node. The agent requesting message, more specifically, refers to a message requesting certain sensor nodes to partially carry out functions of the sink node on behalf of the sink node.

In operation S302, the sink node receives from the adjacent sensor nodes a response message (i.e., an “agent acceptance message”) indicating an acceptance of the request by the respective sink nodes.

In operation S304, the sink node selects one of the sensor nodes that transmitted the agent acceptance message as the agent node, dependent upon a particular criterion. For example, the sink node may select as the agent node the sensor node that first sends an agent acceptance message (i.e., the nearest sensor node). Alternatively, the sink node may select one of the sensor nodes located within one hop as the agent node.

In operation S306, the sink node transmits a message asking the selected agent node to perform agent functions (i.e., an “agent function performing message”). The sensor node receiving the message then performs the agent functions.

FIG. 4 illustrates an example where the sink node requests data collection via the agent node.

In operation S400, the sink node transmits a query message to the selected agent node, where the query message asks the sensor nodes constituting the sensor network to collect data and transmit the collected data to the sink node. The query message includes information including an identifier (ID) of the sink node and the number of hops for setting the route. The sink node transmitting the query message sets its address as the source node.

In operation S402, the agent node broadcasts the query message to the sensor nodes constituting the sensor network. After receipt of the query message broadcast from the agent node, the sensor nodes constituting the sensor network are able to set a route for the return transmission of the collected data to the agent node. Although FIG. 4 illustrates the broadcast of the query message from the agent node to the sensor node, it should be understood that in this embodiment only the sensor nodes located within one hop from the agent node receive the query message broadcast from the agent node. The sensor nodes within one hop from the agent node then update and re-broadcast the received query message to the remaining sensor nodes. By performing the above process, each of the sensor nodes constituting the sensor network receive the query message.

In the sensor network described above, the route for transmitting the collected data may be set in the form of a tree or a mesh according to the user's selection. In the tree-type route, power consumption can be minimized by reducing the number of messages being transceived. However, if an error occurs in the tree-type route, another route has to be newly set. In the mesh-type route, although an error occurs in one selected route, data transmission can be achieved using other routes. However, the mesh-type route requires a large memory capacity to store information on a plurality of routes.

The sensor node receiving the query message collects data according to the request of the sink node. The data that the sensor node collects may include information indicating the ambient temperature and/or movement of an object.

In operation S404, the sensor node transmits the collected data to the agent node. Here, the sensor nodes arranged more than one hop from the agent node do not transmit the data directly to the agent node, but rather transmit it through a reverse route (the tree-type or the mesh-type route) of the route that the query message was transmitted.

In operation S406, the agent node transmits the data to the sink node. In this manner, the agent collects the data according to the request of the sink node.

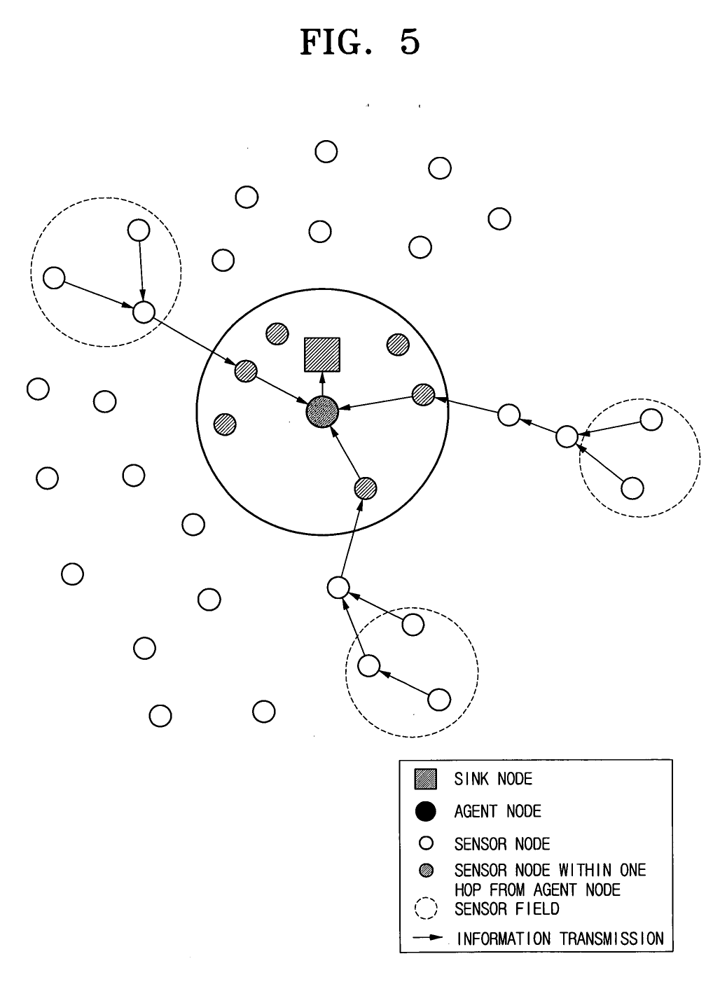

FIG. 5 shows a process of transmitting data collected by a sensor node according to an exemplary embodiment of the invention. In this example, the sink node requests the sensor nodes located in a sensor field to detect the ambient temperature and transmit the detected temperature.

As shown in FIG. 5, upon receiving a query message, the sensor nodes constituting the sensor field detect the ambient temperature and transmit the detected ambient temperature to the agent node through the reverse of a route of transmission of the query message. The agent node receives the detected ambient temperature information, and transmits the data to the sink node.

The sensor nodes located within one hop from the agent node (shown in FIG. 5 as cross-hatched circles) buffer their received data for a predetermined time. The reason for this will be explained hereinafter.

Since the function of the movable sink node can be performed by the static agent node, resetting of transmission routes from the other sensors is not required even if the sink node is moving.

However, when the sink node is moving, it may move beyond a transmission range of the agent node. In such a case, the sink node can no longer receive the data transmitted by the agent node. Accordingly, a new transmission route has to be determined so that the sink node can receive the data collected by the sensor nodes.

To determine such a new transmission route, the sink node broadcasts a relay requesting message to the adjacent sensor nodes in the same manner as it transmits the agent requesting message discussed above. The sink node then selects one of the adjacent sensor nodes which responded to the relay requesting message as the relay node based upon a particular criterion. For example, the sink node may set the sensor node that responded first among the sensor nodes located between itself and the agent node as the relay node.

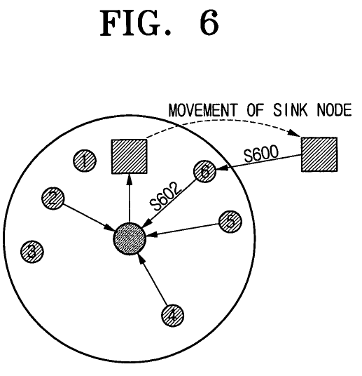

FIG. 6 shows an example of such a process, whereby the sink node sets the relay node to transceive the data from the agent node. FIG. 6 illustrates sensor nodes located within one hop of the agent node of FIG. 5 as cross-hatched numbered circles.

As shown in FIG. 6, the movable sink node cannot collect the data transmitted from the agent node. Therefore, the sink node broadcasts the relay requesting message to the adjacent sensor nodes and receives messages accepting the request from the adjacent sensor nodes. For example, referring to FIG. 6, assuming that sensor nodes 5 and 6 transmit the relay accepting message to the sink node, the sink node may select either one of the sensor nodes 5 or 6 as the relay node. In this example, since the relay accepting message is received first from the sensor node 6, the sensor node 6 is selected as the relay node.

Accordingly, in operation S600, the sink node transmits a relay function performing message to the sensor node 6, which includes an ID of the agent node. Alternatively, the relay function performing message may not include the ID of the agent node in the case where the sensor nodes constituting the sensor network acquire an ID of the agent node by transceiving the query message.

Upon receiving the relay function performing message, the sensor node 6 performs the function of the relay node. First, since the agent node does have the data transmitted from the other sensor nodes, the relay node 6 instructs the agent node to request retransmission of the buffered collected data to the agent node from the nodes located within one hop therefrom in operation S602. The request message includes the ID of relay node 6.

The agent node transmits the received data to the sensor node 6, which in turn transmits the data to the sink node.

Alternatively, the relay node may directly or indirectly request the sensor nodes with the buffered collected data themselves to retransmit the stored data. In this case, the agent node partly loses its function.

When the number of hops between the sink node and the agent node exceeds a preset value as the sink node moves, the sink node may newly set another agent node and a new route for transmitting the data by the agent node.

Hereinbelow, the information stored in the sensor nodes constituting the sensor network will be explained. Each sensor node stores information on the agent node located on the tree-type or the mesh-type route to which each sensor belongs. Also, each sensor node stores information indicating the number of hops to the agent node. The sensor node acquires the information on the agent node and the number of hops from the agent node by receiving the query message from the agent node.

Additionally, in the tree-type route, the sensor node recognizes its upper nodes and lower nodes. When there are plural sink nodes, the sensor node has to be aware of the information required by the sink nodes and the agent nodes corresponding to the respective sink nodes. For this, the sensor node stores the data to be collected, the agent nodes for transmitting the data, and the sink nodes corresponding to the agent nodes in a table form. Therefore, the sensor node may store the sink nodes connected to the respective agent nodes in a table form or store the query messages transmitted from the respective sink nodes in a table form.

An example of the table stored in the sensor node is illustrated as Table 1 below:

TABLE 1

| | | Data to be collected as |
|---|---|---|
| Sink node | Agent node | requested by query |
| first sink node | first agent node | ambient temperature |
| first sink node | second agent node | information on moving object |
| second sink node | second agent node | ambient temperature |
| second sink node | second agent node | wind direction |
| . . . | . . . | . . . |
| n-th sink node | n-th agent node | wind velocity |

When the sink node receives the query message requesting collection of the same information through a new agent node, the sensor node updates the information on the agent node in the table. In other words, the sensor nodes discard the information on a previous agent node and stores information on the new agent node. In addition, after completing collection of the data, the sensor node deletes the information on the corresponding query message, the sink node and the agent node and also deletes the information on the corresponding route. Here, the information on the route is deleted in a predetermined time because a new query message may be transmitted through the route which will be deleted.

As described above, according to an embodiment of the invention, a sensor node which is static is set as the agent node, instead of the sink node which is movable, so that the agent node can perform the function of the sink node on behalf of the sink node, thereby stabilizing the route for data transmission. Accordingly, the number of times that a data transmission route must be set can be reduced, which: (1) reduces the load in the sensor network, thereby alleviating any retardation of data transmission; and (2) decreasing power consumption.

While the invention has been shown and described with reference to exemplary embodiments thereof, the invention is not limited to these embodiments. It will be understood by those of ordinary skill in the art that various changes in form and details may be made therein without departing from the spirit and scope of the invention as defined by the appended claims.

What is claimed is:

1. A method for setting a data transmission route in a sensor network comprising a movable sink node and a plurality of sensor nodes which collect data requested by the movable sink node, the method comprising:
transmitting an agent requesting message from the movable sink node to the sensor nodes;
receiving a first agent acceptance message from a first sensor node of the sensor nodes; and
selecting, as an agent node, the first sensor node

2. The method of claim 1, further comprising requesting the agent node to receive the collected data from other sensor nodes of the sensor nodes on behalf of the movable sink node.

3. The method of claim 1, wherein the first agent acceptance message is received in response to the agent requesting message.

4. The method of claim 1, further comprising receiving a second agent acceptance message from a second sensor node of the sensor nodes, and deciding that the first sensor node of the sensor nodes is more appropriate based upon a defined criterion.

5. The method of claim 4, wherein the defined criterion is a distance from the movable sink node.

6. The method of claim 2, wherein the agent node transmits a query message, to the other sensor nodes, which includes an address of the agent node, which is set as a source node.

7. The method of claim 6, wherein the query message further includes a number of hops.

8. The method of claim 2, further comprising transmitting, from the agent node to the movable sink node, the collected data received from the other sensor nodes.

9. The method of claim 2, further comprising storing the collected data in the other sensor nodes for a defined time if the other sensor nodes are located within one hop of the sink node.

10. The method of claim 2, further comprising, if the movable sink node moves beyond a transmission range of the agent node, setting a relay node for transmitting the collected data, received from the other sensor nodes, from the agent node to the movable sink node.

11. The method of claim 9, further comprising, if the movable sink node moves beyond a transmission range of the agent node, setting a relay node for transmitting the collected data, received from the other sensor nodes, from the agent node to the movable sink node.

12. The method of claim 1 1, further comprising requesting retransmission of the collected data stored in the other sensor nodes within one hop of the movable sink node to the relay node.

13. The method of claim 1, wherein the other sensor nodes store information on the movable sink node, the agent node, and the collected data requested by the movable sink node.

14. A data transmission route setting system comprising:
a plurality of sensor nodes which collect data; and
a movable sink node which transmits an agent requesting message to the sensor nodes, which receives a first agent acceptance message from a first sensor node of the sensor nodes, and which selects as an agent node, the first sensor node.

15. The data transmission route setting system of claim 14, wherein the movable sink node also requests the agent node to receive the collected data from other sensor nodes of the sensor nodes on behalf of the sink node.

16. The data transmission route setting system of claim 14, wherein the first agent acceptance message is received in response to the agent requesting message.

17. The data transmission route setting system of claim 14, wherein the movable sink node also receives a second agent acceptance message from a second sensor node of the sensor nodes, and decides that the first sensor node is more appropriate based upon a defined criterion.

18. The data transmission route setting system of claim 17, wherein the defined criterion is a distance from the movable sink node.

19. The data transmission route setting system of claim 15, wherein the agent node transmits a query message to the other sensor nodes which includes an address of the agent node which is set as a source node.

20. The data transmission route setting system of claim 19, wherein the query message further includes a number of hops.

21. The data transmission route setting system of claim 15, wherein the agent node transmits the collected data received from the other sensor nodes to the movable sink node.

22. The data transmission route setting system of claim 15, wherein, the other sensor nodes store the collected data for a defined time when the other sensor nodes are located within one hop of the sink node.

23. The data transmission route setting system of claim 15, wherein, the movable sink node sets a relay node for transmitting the collected data, received from the other sensor nodes, from the agent node to the sink node, when the movable sink node moves beyond a transmission range of the agent node.

24. The data transmission route setting system of claim 22, wherein, the movable sink node sets a relay node for transmitting the collected data, received from the other sensor nodes, from the agent node to the movable sink node, when the movable sink node moves beyond a transmission range of the agent node.

25. The data transmission route setting system of claim 24, wherein, the relay node requests retransmission of the collected data from the other sensor nodes within one hop of the movable sink node.

26. The data transmission route setting system of claim 14, wherein the other ones of the sensor nodes store information on the movable sink node, the agent node, and the collected data requested by the movable sink node.
